(19) United States
(12) Patent Application Publication
(10) Pub. No.: US 2011/0114576 A1
(43) Pub. Date: May 19, 2011

(54) RACK ENCLOSURE

(75) Inventors: YI-LIANG HSIAO, Tu-Cheng (TW); ZHONG-YANG YAN, Shenzhen City (CN); HSUEH-CHIN LU, Tu-Cheng (TW)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/855,886

(22) Filed: Aug. 13, 2010

(30) Foreign Application Priority Data
Nov. 13, 2009 (CN) 200910309698.4

(51) Int. Cl. A47B 81/00; F16M 13/02

(52) U.S. Cl. 211/26; 248/201

(57) ABSTRACT

A rack enclosure includes a cuboid frame, and two opposite first brackets and two opposite second brackets mounted on the frame for securing an electronic device thereon. Each of the first brackets includes a mounting plate secured on the frame and a guide portion distorting angularly from a side of the mounting plate along a direction away from an opposite side of the mounting plate for guiding an end of the electronic device. The guide portion includes a connecting plate connecting with the mounting plate and a guide plate distorting angularly from the connecting plate along the direction away the opposite side of the mounting plate. An angle defined between the guide plate and the connecting plate is not smaller than 90 degrees.

### CROSS-REFERENCE TO RELATED APPLICATION

This patent application is related to a co-pending U.S. patent application, titled “RACK ENCLOSURE”, with the application Ser. No. 12/854,299 (Attorney Docket No. US30069), assigned to the same assignee, and disclosure of which is incorporated herein by reference in its entirety.

### BACKGROUND

1. Technical Field

The disclosure relates to a rack enclosure.

2. Description of Related Art

A typical rack enclosure includes a hollow cuboid frame and four brackets vertically secured on the frame. Electronic devices, such as servers, are commonly arranged on the brackets and are stacked vertically within the rack enclosure. The brackets generally meet industry standard of EIA-310-D or other industry standards. In order to secure the electronic devices on the brackets, it needs to have two additional extendable rail assemblies mounted to two opposite sides of the frame, from front to back on each side of the frame. That results in the inconvenience of the assembly of the electronic devices.

What is needed, therefore, is a rack enclosure which overcomes the above-mentioned limitations.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric, assembled view of a rack enclosure with first brackets in accordance with a first embodiment, wherein the rack enclosure includes second brackets, and has an electronic device mounted on the first and second brackets.

FIG. 2 is an isometric view of one of the first brackets of the rack enclosure of FIG. 1.

FIG. 3 is a top plan view of the one of the first brackets of FIG. 2.

FIGS. 4-5 are schematic views of the process of mounting the electronic device on the first and second brackets of the rack enclosure of FIG. 1.

FIG. 6 is an isometric view of one of first brackets in accordance with a second embodiment, wherein the first brackets are used in the rack enclosure of FIG. 1.

FIG. 7 is a top plan view of the one of the first brackets of FIG. 6.

FIG. 8 is an isometric view of one of first brackets in accordance with a third embodiment, wherein the first brackets are used in the rack enclosure of FIG. 1.

FIG. 9 is a top plan view of the one of the first brackets of FIG. 8.

### DETAILED DESCRIPTION

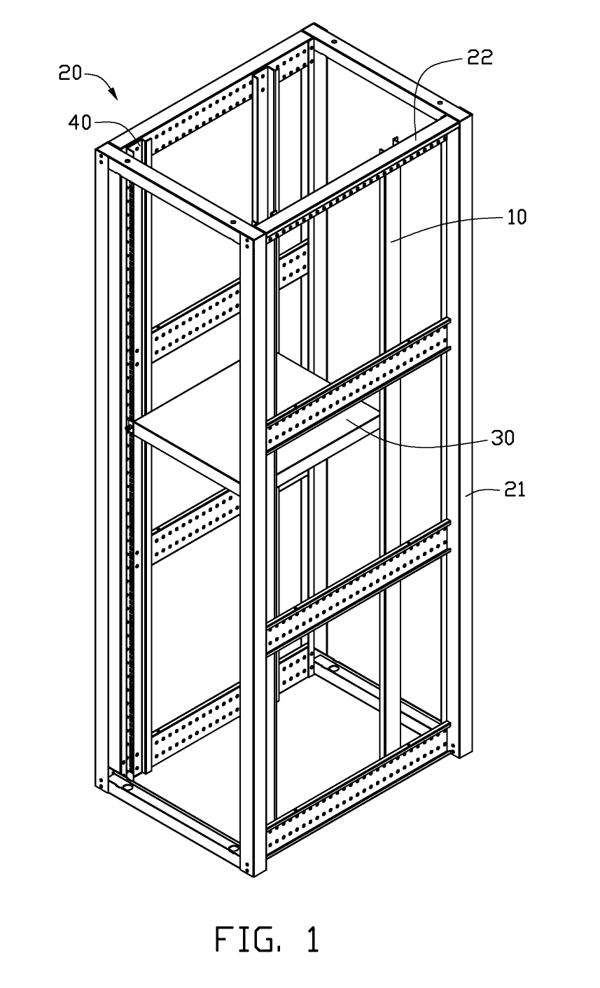

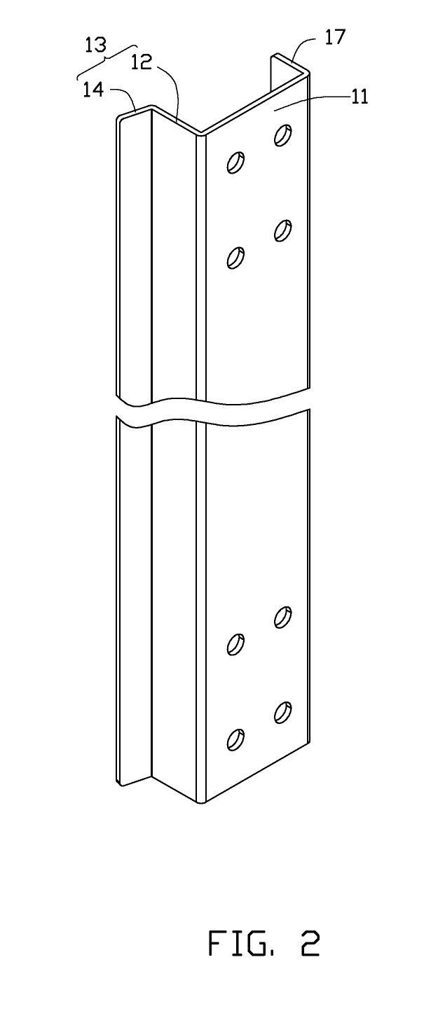

Referring to FIGS. 1-2, a rack enclosure 20 comprises a hollow cuboid frame 21, a pair of first brackets 10 in accordance with a first embodiment, and a pair of second brackets 40. The first brackets 10 are vertically mounted to two opposite sides of the frame 21, and face each other. The second brackets 40 are vertically mounted to the opposite sides of the frame 21, and face each other. The pair of first brackets 10 is separated by a distance from the pair of second brackets 40. In this embodiment, an electronic device 30 is mounted on the first and second brackets 10, 40. In other embodiments, multiple electronic devices 30 can be horizontally arranged on the first and second brackets 10 and 40, and stacked within the rack enclosure 20. Each of the second brackets 40 meets industry standard of EIA-310-D. By changing the distance between the pair of first brackets 10 and the pair of second brackets 40, electronic devices 30 with different sizes can be arranged on the first and second brackets 10 and 40.

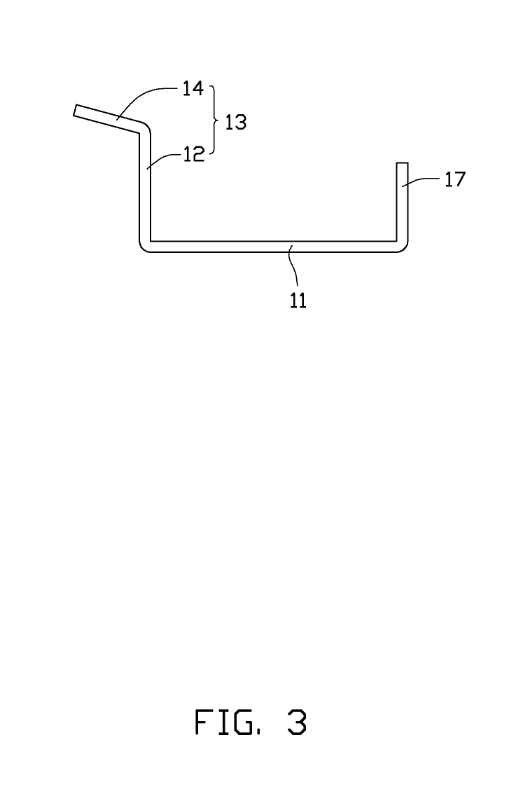

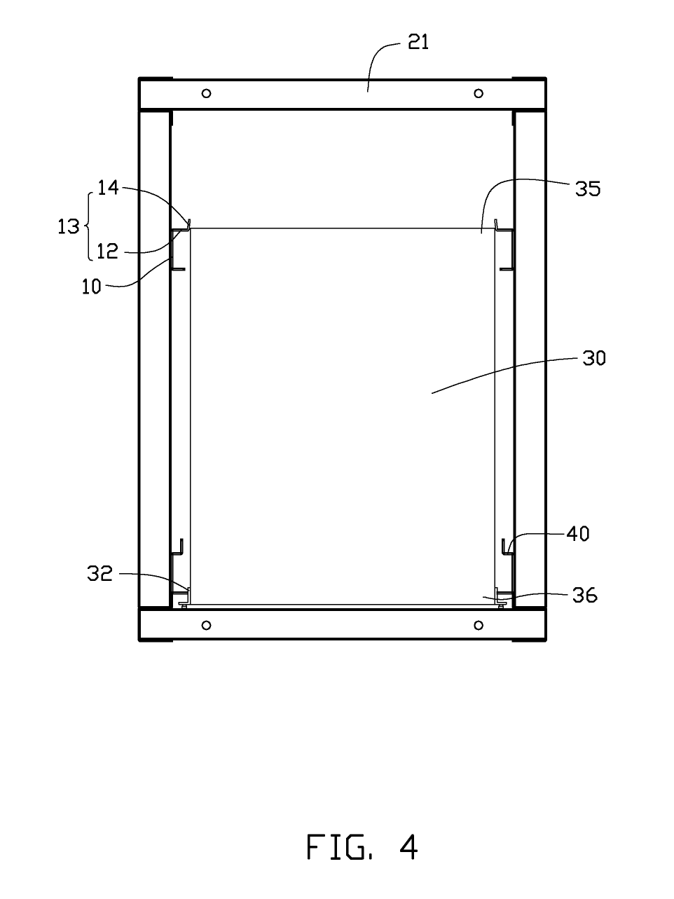

Referring also to FIGS. 3-4, each of the first brackets 10 has an elongated configuration. Each first bracket 10 is integrally formed as a single piece. Each first bracket 10 comprises a rectangular mounting plate 11, a guide portion 13 distorting angularly from a side of the mounting plate 11, and a distorted plate 17 extending from an opposite side of the mounting plate 11. The distorted plate 17 is substantially perpendicular to the mounting plate 11. The guide portion 13 includes a connecting plate 12 connecting with the mounting plate 11 and a guide plate 14 distorting angularly from the connecting plate 12 along the direction away from the distorted plate 17. The connecting plate 12 is substantially parallel to the distorted plate 17. The connecting plate 12 and the distorted plate 17 extend towards a same direction substantially perpendicular to the mounting plate 11. The connecting plate 12 has a width larger than the distorted plate 17. An obtuse angle is defined between the connecting plate 12 and the guide plate 14, it may be, for instance, approximately 115 degrees.

In other embodiments, the first brackets 10 may not include the distorted plate 17. An obtuse angle is defined between the connecting plate 12 and the mounting plate 11.

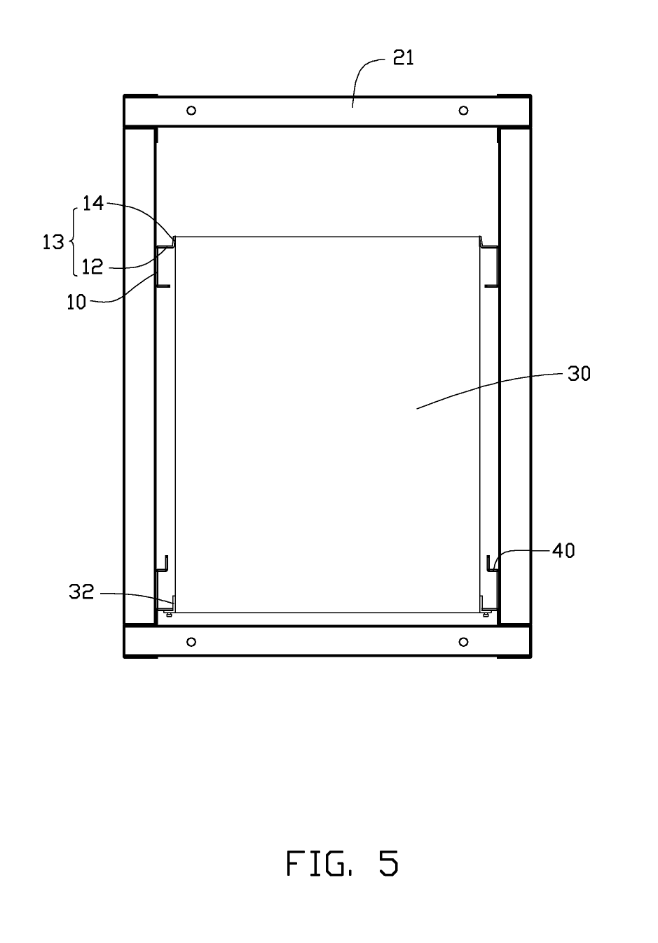

Referring also to FIGS. 4-5, the electronic device 30 has two first corners 35 close to the first brackets 10 and two second corners 36 close to the second brackets 40. The first corners 35 are guided by the guide portion 13 of the first brackets 10 to slide towards a free side of the guide portion 13. The second corners 36 are secured to the second brackets 40 by securing members 32.

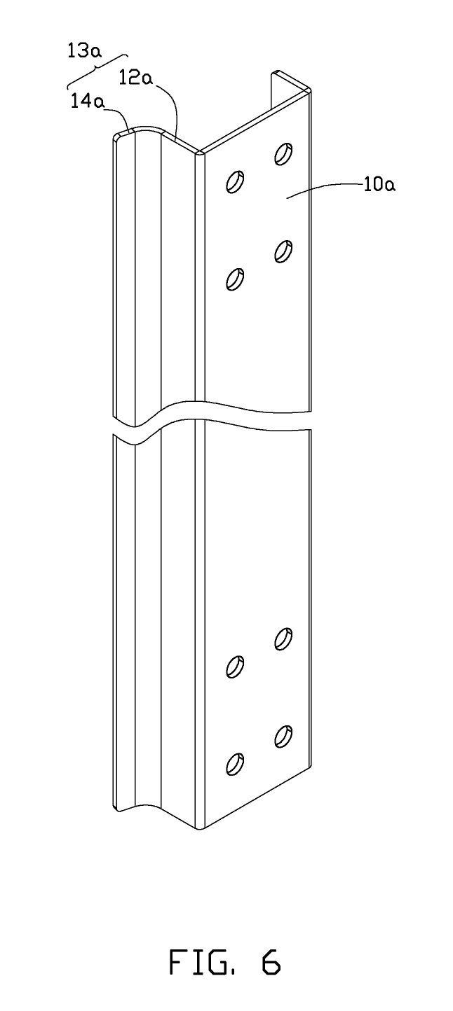

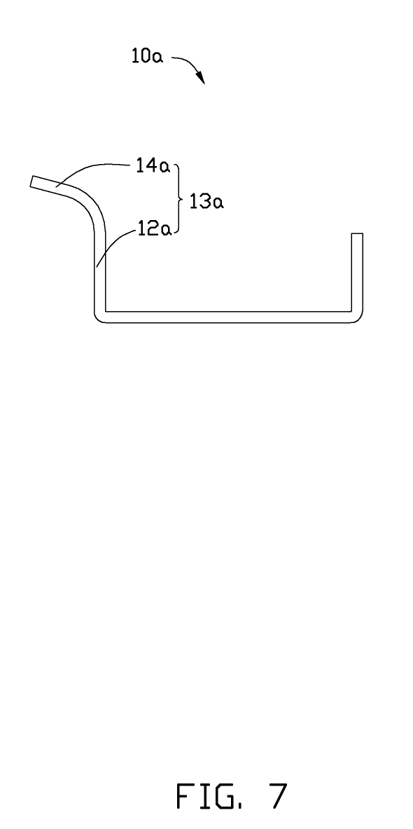

Referring also to FIGS. 6-7, a first bracket 10a in accordance with a second embodiment is used in the rack enclosure 20. The first bracket 10a of the second embodiment is similar to the first bracket 10 of the first embodiment. The main difference is that a connecting portion between the connecting plate 12a and the guide plate 14a of the guide portion 13a is connected with a curved portion (not labeled). The connecting portion with the curved portion can guide the first corners 35 of the electronic device 30 to slide towards a free side of the guide portion 13a.

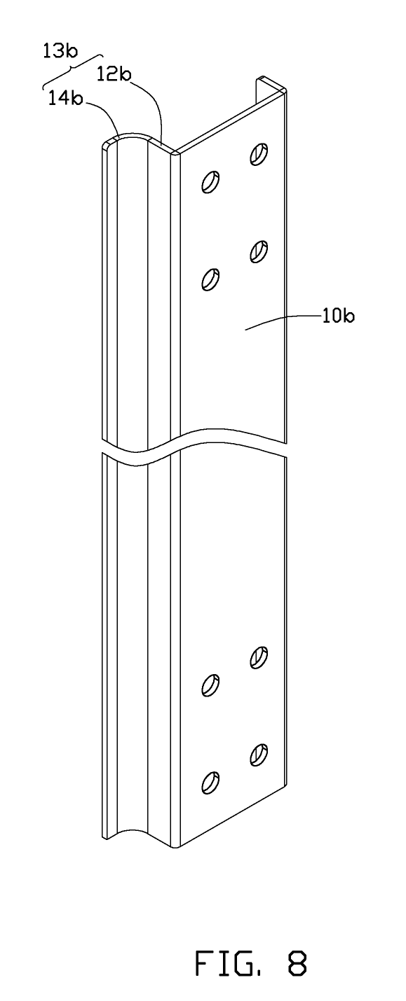

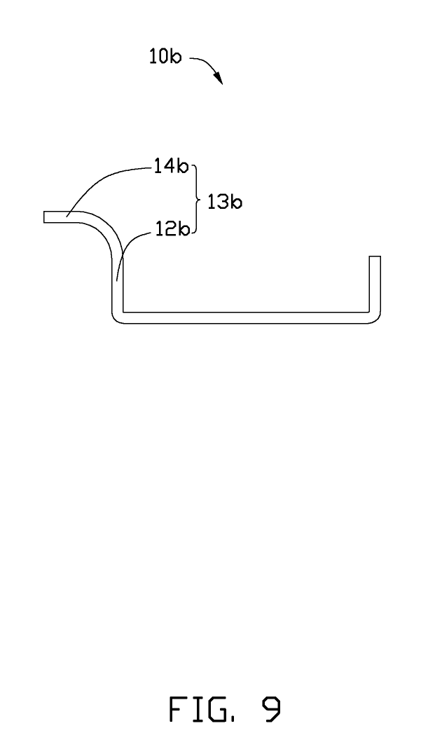

Referring also to FIGS. 8-9, a first bracket 10b in accordance with a third embodiment is used in the rack enclosure 20. The first bracket 10b of the third embodiment is similar to the first bracket 10 of the first embodiment. The main difference is that an angle between the connecting plate 12b and the guide plate 14b of the guide portion 13b is a right angle, and a connecting portion between the connecting plate 12b and the guide plate 14b is connected with a curved portion (not labeled). In this embodiment, the connecting portion between the connecting plate 12b and the guide plate 14b is an 8 mm fillet. The connecting portion with the curved portion can guide the first corners 35 of the electronic device 30 to slide towards a free side of the guide portion 13b.

The first brackets 10, 10a and 10b cooperate with the second brackets 40 meeting the industry standard of EIA-310-D to install the electronic device 30, respectively in the first, second and third embodiment. There is no need for any extendable rail assemblies mounted on the frame 21. In view of the guide function of the guide portions 13, 13a and 13b, the assembly of the electronic device 30 is convenient.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A rack enclosure comprising:
a frame;
two opposite first brackets and two opposite second brackets mounted on the frame for securing an electronic device thereon, each of the first brackets comprising a mounting plate secured on the frame and a guide portion distorting angularly from a side of the mounting plate along a direction away an opposite side of the mounting plate for guiding an end of the electronic device, the guide portion comprising a connecting plate connecting with the mounting plate and a guide plate distorting angularly from the connecting plate along the direction away the opposite side of the mounting plate, an angle defined between the guide plate and the connecting plate being not smaller than 90 degrees.

2. The rack enclosure of claim 1, wherein the connecting plate is perpendicular to the guide plate, a connection portion between the connecting plate and the guide plate of the guide portion being curved.

3. The rack enclosure of claim 2, wherein the connecting portion between the connecting plate and the guide plate is an 8 mm fillet.

4. The rack enclosure of claim 1, wherein the angle defined between the connecting plate and the guide plate is 115 degrees.

5. The rack enclosure of claim 4, wherein a connection portion between the connecting plate and the guide plate of the guide portion is curved.

6. The rack enclosure of claim 1, wherein the connecting plate is perpendicular to the mounting plate.

7. The rack enclosure of claim 1, wherein each of the first brackets further comprises a distorted plate extending from the opposite side of the mounting plate, the distorted plate having a width smaller than the connecting plate.

8. The rack enclosure of claim 7, wherein the distorted plate are perpendicular to the mounting plate.

9. The rack enclosure of claim 1, wherein each of the first brackets is integrally formed as a single piece.
